(19) United States
(12) Patent Application Publication
(10) Pub. No.: US 2015/0069892 A1
(43) Pub. Date: Mar. 12, 2015

(54) OVERHEAD STORAGE SYSTEM

(71) Applicant: MARK ROBERT SCHNEIDER, SAN DIEGO, CA (US)

(72) Inventor: MARK ROBERT SCHNEIDER, SAN DIEGO, CA (US)

(21) Appl. No.: 14/475,056

(22) Filed: Sep. 2, 2014

Related U.S. Application Data
(60) Provisional application No. 61/875,225, filed on Sep. 9, 2013.

(51) Int. Cl. A47B 96/14; A47B 81/00; F16M 13/02

(52) U.S. Cl. CPC A47B 96/1425; F16M 13/027; A47B 81/00
USPC 312/245; 248/343

(57) ABSTRACT

An overhead or ceiling-mounted storage system is disclosed. The system includes two or more rails. A rail includes one or more lips that may support a bin. The bin includes substantially straight opposing walls topped with a rim or other structure that may contact the lip of a rail. The rails may support the bin when the rim is placed on the rails and the rails are attached to an overhead structure, such as a ceiling. The lips of the rails and the rims of the bins are configured such that the lips substantially maintain contact with the rims across each of their respective widths.

### CROSS-REFERENCE TO RELATED APPLICATIONS

This application claims the benefit of U.S. Provisional Application No. 61/875,225, filed Sep. 9, 2013, which is incorporated herein by reference in its entirety.

### BACKGROUND

The embodiments herein relate generally to overhead or ceiling-mounted storage systems utilizing bins and rails.

Storage space is highly desirable. Rental rates for storage spaces are at an all-time high. Closet size in newly constructed homes continues to increase. Homes with ample storage space, for example in a garage, attic, or basement, are more desirable. A simple and cost-effective way to increase available storage space is to use shelves or other systems to move beyond square footage and store items along a vertical axis.

In a garage, the floor is typically used to store vehicles, yard and lawn equipment, or other items that need to be frequently accessed. Shelves can be placed along walls to create vertical storage, but they cannot be used to create or expand storage, e.g., above a vehicle. Current solutions hang a shelf or rack from the ceiling, creating a suspended surface where items can be stored. However, placing items on and retrieving items from such a shelf can be a difficult and awkward process. This problem is compounded if smaller items are stored inside a bin and the bin is placed on the hanging shelf. One must retrieve and search through each bin to locate the desired item.

U.S. Pat. No. 7,597,203 is directed to a storage system comprising one or more storage containers which form an array of storage containers, at least two rail units that attach to a ceiling or a wall to create a hanging apparatus. Each of the rail units have one or more parallel support rails, at least two inner adjacently parallel reinforcement rods, one or more outer parallel reinforcement rods, and a plurality of inverted u-shaped brackets. Each of the storage containers has an upper lip to allow the containers to adjustably and horizontally slide along and between the parallel support rails. However, the parallel support rails only provide a single point of contact between the rail and the upper lip of the container, resulting in an unstable and unsafe design. In addition, the parallel support rails are not strong enough to hold a container of substantial weight. Finally, the thin design of the parallel support rails results in bending of the rails over time.

### SUMMARY

According to an embodiment of the present invention, an overhead storage system stores items in a substantially straight-walled bin supported by rails attached to a ceiling or other overhead structure. The system includes two or more rails and one or more bins. A rail includes a body and a lip configured to support a bin. A rail is configured to connect to an overhead structure, such as a ceiling. A bin includes at least two opposing, substantially straight walls, and a straight wall includes a rim configured to support the bin when the rim is in contact with at least one rail. The rails are configured to support bin when the rim of the bin is in contact with the rails and the rails are connect to an overhead structure. The lip of the rail and the rim of the bin are configured such that the lip substantially maintains contact with the rim across each of their respective widths. In another embodiment, the rail is composed of a material strong enough to support bins with a weight of at least 20 pounds, for example aluminum.

### BRIEF DESCRIPTION OF THE FIGURES

The detailed description of some embodiments of the present invention is made below with reference to the accompanying figures, wherein like numerals represent corresponding parts of the figures.

FIG. 1 shows a schematic perspective view of one embodiment of the present invention; and

FIG. 2 shows a detail schematic perspective view of the embodiment shown in FIG. 1.

### DETAILED DESCRIPTION OF CERTAIN EMBODIMENTS

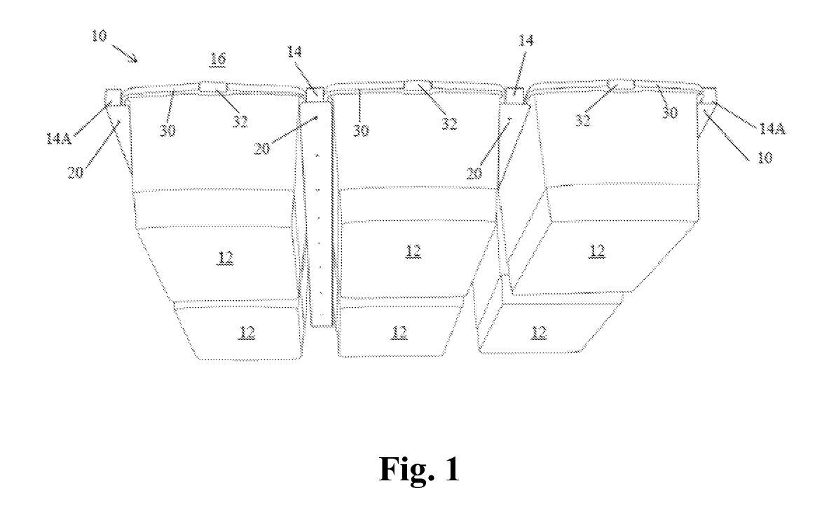

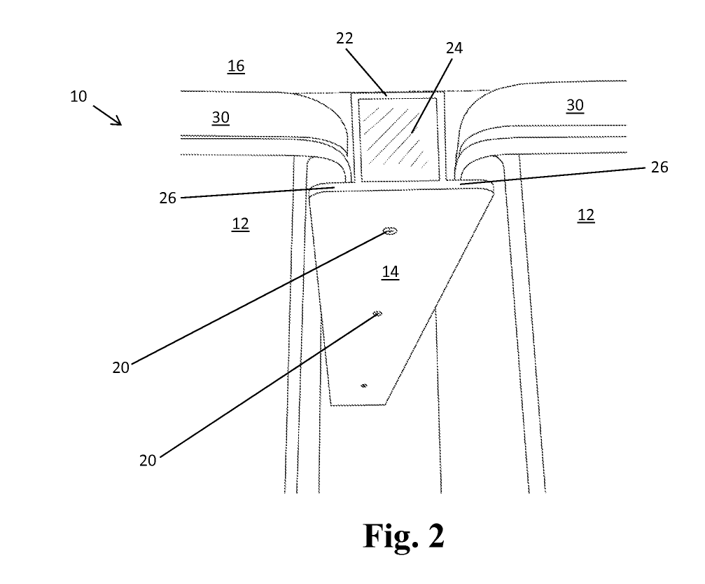

By way of example, and referring to FIGS. 1 and 2, one embodiment of the present invention comprises a ceiling-mounted storage system 10 utilizing bins 12 and rails 14. A rail 14 may be connected to a ceiling 16 by one or more fasteners 20. Different fasteners 20 may be used, depending on the construction of the ceiling 16, as will be apparent to those skilled in the art. For example, toggle bolts may be used if the rail 14 is attached to sheetrock, while wood screws may be used if the rail 14 is attached to a stud or beam in the ceiling 16. A rail 14 may include a body 22 with a square or rectangular cross-section, which may define a central cavity 24. A rail 14 may include one or more lips 26. A rail 14 with one lip 26 may be used as an end rail 14A, which may be positioned as an outermost rail 14 in a storage system 10.

A bin 12 may include a bottom 30 and four walls 32, which may define an opening. The top of a wall 32 may be flared outward, forming a rim 34. The rim 34 may receive a lid 36 for the bin 12. The lid 36 may include a latch 38 or other means of securing the lid 36 to the bin. The rim 34 may have width that is sufficient to support the bin 12 when rims 34 on opposite walls 32 of the bin 12 are supported. The lip 26 of the rail 14 may have a width that is sufficient to accommodate the rim 34. The lip 26 of the rail 14 and the rim 34 of the bin 12 are configured such that the lip 26 substantially maintains contact with the rim 34 across each of their respective widths.

In use, two or more rails 14 may be attached to a ceiling 16 or other overhead structure. The spacing between an adjacent pair of rails 14 may be sufficient to accommodate a bin 12. For example, the distance between rail lips 26 may be roughly equal to an outer distance between opposite walls 32 of the bin 12, and the distance between rail bodies 22 may be roughly equal to an outer distance between rims 34 on opposite walls 32 of the bin 12. Rails 14 may have a length that is sufficient to accommodate one or more bins 12.

Current storage bins have sides that are slightly bowed or curved, which may not provide sufficient contact between the bin's rim and the rails 14 to support the weight of the bin. A bin 12 may have opposite walls 32 that are largely or substantially straight, which may enable the rails 14 to sufficiently support the bin 12. The bin 12 may be made of plastic or any other suitable material. The bin 12 may be clear, transparent, translucent, or opaque. A clear, transparent, or translucent bin 12 may allow the contents to be more easily examined without removing the bin 12 from the rails 14. The bin 12 may include a label or decal for recording and/or displaying a list of the contents of the bin 12. A bin 12 may be any size. A bin 12 may be sized so that an average person may lift it to the ceiling and slide it onto the rails 14 when the bin 12 is filled with common household items. As a non-limiting example only, a bin 12 may be roughly 26 inches long, 16 inches wide, and 14 inches tall.

The ceiling-mounted storage system 10 may allow for storage to be mounted as high as possible in a garage or other locations, such as, e.g., storage unit, office, warehouse, etc. The system 10 may allow a full view of the contents inside and may provide a clean, consistent appearance.

In another embodiment, the rails 14 is composed of a material strong enough to support bins 12 with a weight of at least 20 pounds, at least 25 pounds, at least 30 pounds, at least 35 pounds, at least 40 pounds, at least 45 pounds, or at least 50 pounds. Such materials may include, but are not limited to, aluminum.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A system for storing items in a substantially straight-walled bin supported by rails attached to a ceiling or other overhead structure, the system comprising:
a plurality of rails comprising a body and a lip configured to support a bin, the rails configured to be connected to an overhead structure; and
a bin comprising at least two opposing substantially straight walls, the substantially straight walls comprising a rim configured to support the bin when the rim is in contact with at least one of the plurality of rails,
wherein the rails are configured to support the bin when the rim of the bin is in contact with the rails and the rails are connected to an overhead structure, and further wherein the lips of the rails and the rims of the bins are configured such that the lips substantially maintain contact with the rims across each of their respective widths.

2. The system of claim 1, wherein the rails are composed of a material strong enough to support bins with a weight of at least 20 pounds.

3. The system of claim 2, wherein the material is aluminum.
